(19) United States
(12) Patent Application Publication
(10) Pub. No.: US 2003/0191753 A1
(43) Pub. Date: Oct. 9, 2003

(54) Filtering contents using a learning mechanism

(76) Inventor: Michael Hoch, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/400,018

(22) Filed: Mar. 25, 2003

Related U.S. Application Data
(60) Provisional application No. 60/371,111, filed on Apr. 8, 2002.

(51) Int. Cl. G06F 17/30

(52) U.S. Cl. 707/3

(57) ABSTRACT

Filtering contents using a learning mechanism is described herein. When a request to search for a content in a community is received, a search is performed for the content at one or more nodes of the community. Information received from the one or more nodes is filtered based on persona information of the user using a learning mechanism. A search result is generated based on the filtered information.

### RELATED APPLICATIONS

This application claims the benefit of U.S. Provisional Application No. 60/371,111, filed Apr. 8, 2002, which is hereby incorporated by reference.

### FIELD OF THE INVENTION

This invention relates generally to filtering information, and more particularly to filtering information using a learning mechanism.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2003, Sony Electronics, Inc., All Rights Reserved.

### BACKGROUND OF THE INVENTION

A process of selecting products or entertainment very often is collaborative. Typically, it begins with talking with friends, followed by research and information gathering. A few choices are then previewed before eliminating and making the final purchase. Thereafter, the cycle begins anew. Many sites have grown strong by allowing their users to participate in this behavior by allowing them to sort, rank, and define existing media and each other (e.g., epinions.com, AOL Chatrooms, or eBay, etc.).

In order to leverage this emergence of group intelligence and the value that a networked community offers, a service can become successful by tying opinions to distribution methods to create a one-stop-shop for gaining recommendations to making purchases. The challenge comes with the need to create a nomadic inventory of the community space that reflects the user's personality, behaviors, and habits. Conventional approaches only accept input terms entered by a user.

### SUMMARY OF THE INVENTION

Filtering contents using a learning mechanism is described herein. When a request to search for a content in a community is received, a search is performed for the content at one or more nodes of the community. Information received from the one or more nodes is filtered based on persona information of the user using a learning mechanism. A search result is generated based on the filtered information.

### BRIEF DESCRIPTION OF THE DRAWINGS

The invention is illustrated by way of example and not limitation in the figures of the accompanying drawings in which like references indicate similar elements.

FIG. 1A is a block diagram illustrating a computer network which may be used with one embodiment of the invention.

FIG. 1B is a block diagram illustrating a peer-to-peer network which may be used with one embodiment of the invention.

FIG. 2 is a block diagram illustrating a computer system which may be used with one embodiment of the invention.

FIGS. 3A to 3D show block diagrams illustrating embodiments of multilevel hierarchical search and filtering processes.

FIG. 4 shows a block diagram illustrating a data presentation format according to one embodiment.

FIGS. 5A and 5B show block diagrams illustrating user interfaces according to yet another embodiment.

FIG. 6 is a flow diagram illustrating an embodiment of a filtering process.

FIG. 7 is a flow diagram illustrating another embodiment of a filtering process.

FIG. 8 is a flow diagram illustrating yet another embodiment of a filtering process.

FIG. 9 shows a user interface which may be used with an embodiment of the invention.

FIGS. 10A and 10B show user interfaces which may be used to display one or more peers in a community.

FIG. 11 shows another user interface which may be used with one embodiment of the invention.

FIG. 12 shows yet another user interface which may be used with one embodiment of the invention.

### DETAILED DESCRIPTION OF THE INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar data processing device, that manipulates and transforms data represented as physical (e.g. electronic) quantities within the computer system's registers and memories into other data similarly represented as physical quantities within the computer system memories or registers or other such information storage, transmission or display devices.

The present invention also relates to apparatuses for performing the operations described herein. An apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as Dynamic RAM (DRAM), EPROMs, EEPROMs, magnetic or optical cards, or any type of media suitable for storing electronic instructions, and each of the above storage components is coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods. The structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Accordingly, embodiments of the present invention are described herein to enable a user to easily find people with similar interests or having similar contents in a community networked space. According to one embodiment, a level-of-detail (LOD) algorithm is applied to identify a space of users in a browseable hierarchy. A learning algorithm, such as a genetic algorithm or a neural network algorithm, is invoked to allow a user to easily stipulate which results he/she likes and which the user does not like. In one embodiment, a rating mechanism, such as a “thumb-up” rating, is utilized. The search learns from a simple user input by providing a new search hit list by applying a learning algorithm to a set of search features. As searches get more converged, more parameters may be used in the learning algorithm. Overtime, the search becomes more adapted to the user's interests, as well as, becoming more fine grained as new levels of parameters are used to search. In a particular embodiment, the search can be applied to a multimedia field, such as music, to allow the sorting of music, receiving and creating recommendations, and tailoring individual broadcasts.

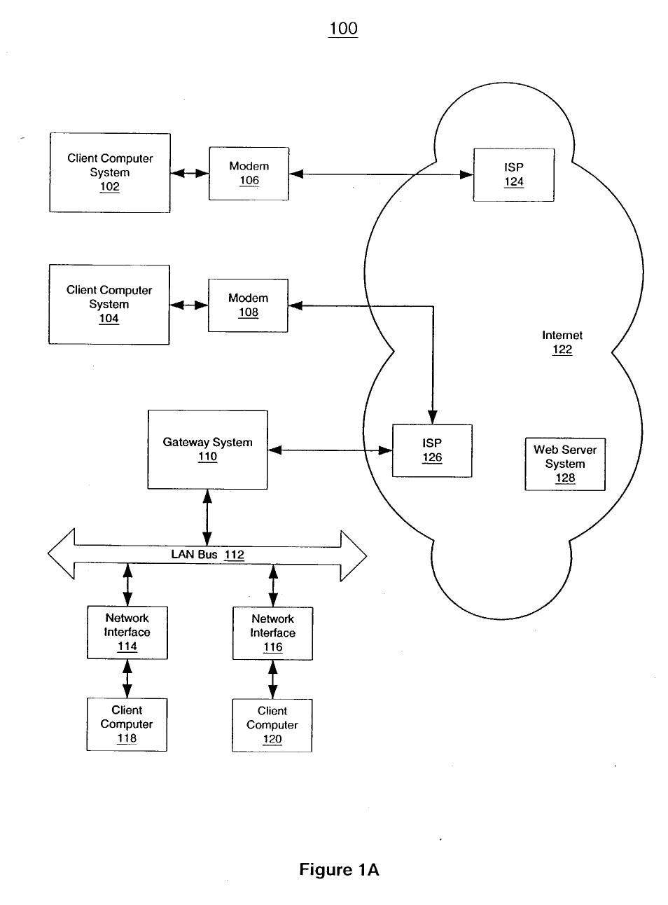

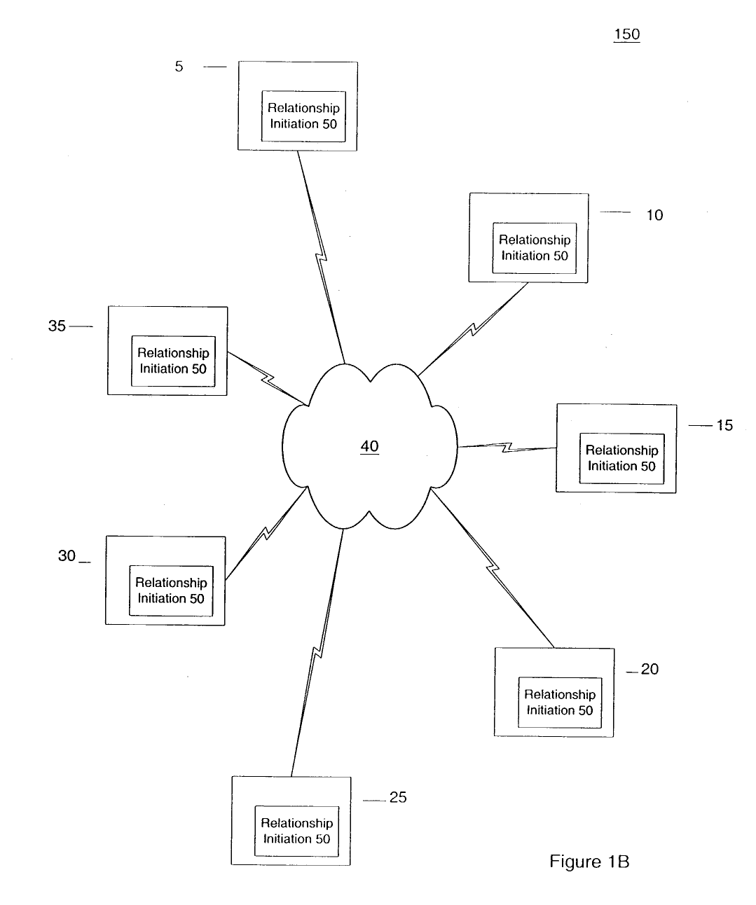

FIG. 1A is a diagram of a network of computer systems in which a hierarchical search that uses a learning mechanism may be practiced, according to one embodiment of the present invention. As shown in FIG. 1, a network 100 includes a number of client computer systems that are coupled together through an Internet 122. It will be appreciated that the term “Internet” refers to a network of networks. Such networks may use a variety of protocols for exchange of information, such as TCP/IP, ATM, SNA, SDI, etc. The physical connections of the Internet and the protocols and communication procedures of the Internet are well known to those in the art. It will be also appreciated that such system may be implemented in an Intranet within an organization.

Access to the Internet 122 is typically provided by Internet service providers (ISPs), such as the ISP 124, and the ISP 126. Users on client systems, such as the client computer systems 102, 104, 118, and 120, generally obtain access to the Internet through Internet service providers, such as ISPs 124 and 126. Access to the Internet may facilitate transfer of information (e.g., email, text files, media files, etc.) between two or more digital processing systems, such as the client computer systems 102, 104, 118, and 120 and/or a Web server system 128. For example, one or more of the client computer systems 102, 104, 118, and 120 and/or the Web server 128 may provide document presentations (e.g., a Web page) to another one or more of the client computer systems 102, 104, 118, and 120 and/or Web server 128. For example, in one embodiment of the invention, one or more client computer systems 102, 104, 118, and 120 may request to access a document that may be stored at a remote location, such as the Web server 128. In the case of remote storage, the data may be transferred as a file (e.g., download) and then displayed (e.g., in a window of a browser) after transferring the file. In another embodiment, the document presentation may be stored locally at the client computer systems 102, 104, 118, and/or 120. In the case of local storage, the client system may retrieve and display the document via an application, such as a word processing application. Without requiring a network connection.

The Web server 128 typically includes at least one computer system to operate with one or more data communication protocols, such as the protocols of the World Wide Web, and as such, is typically coupled to the Internet 122. Optionally, the Web server 128 may be part of an ISP which may provide access to the Internet and/or other network(s) for client computer systems. The client computer systems 102, 104, 118, and 120 may each, with appropriate Web browsing software, access data, such as HTML document (e.g., Web pages), which may be provided by the Web server 128. The browsing software may incorporate a snapback interface in accordance with one embodiment of the invention, to allow a user to directly retrieve a document presentation from a recorded location without having to go through the intermediate pages.

The ISP 124 provides Internet connectivity to the client computer system 102 via a modem interface 106, which may be considered as part of the client computer system 102. The client computer systems 102, 104, 118, and 120 may be a conventional data processing system, such as a Power Mac G4 or iMac computer available from Apple Computer, Inc., a “network” computer, a handheld/portable computer, a cell phone with data processing capabilities, a Web TV system, or other types of digital processing systems (e.g., a personal digital assistant (PDA)).

Similarly, the ISP 126 provides Internet connectivity for the client computer systems 102, 104, 118, and 120. However, as depicted in FIG. 1, such connectivity may vary between various client computer systems, such as the client computer systems 102, 104, 118, and 120. For example, as shown in FIG. 1, the client computer system 104 is coupled to the ISP 126 through a modem interface 108, while the client computer systems 118 and 120 are part of a local area network (LAN). The interfaces 106 and 108, shown as modems 106 and 108, respectively, may represent an analog modem, an ISDN modem, a DSL modem, a cable modem, a wireless interface, or other interface for coupling a digital processing system, such as a client computer system, to another digital processing system. The client computer systems 118 and 120 are coupled to a LAN bus 112 through network interfaces 114 and 116, respectively. The network interface 114 and 116 may be an Ethernet-type, asynchronous transfer mode (ATM), or other type of network interface. The LAN bus is also coupled to a gateway digital processing system 110, which may provide firewall and other Internet-related services for a LAN. The gateway digital processing system 110, in turn, is coupled to the ISP 126 to provide Internet connectivity to the client computer systems 118 and 120. The gateway digital processing system 110 may, for example, include a conventional server computer system. Similarly, the Web server 128 may, for example, include a conventional server computer system.

According to some embodiments of the invention, network 100 may include a peer-to-peer network. For instance, client computers 102, 104, 118, and 120 may be coupled together to form a peer-to-peer network. Peer-to-peer computing is the sharing of computer resources, such as music or movies, and services by direct exchange between systems (e.g., peers). These resources and services include the exchange of information, processing cycles, cache storage, and disk storage for files. Peer-to-peer computing takes advantage of existing desktop computing power and networking connectivity, allowing economical clients to leverage their collective power to benefit the entire enterprise.

In a peer-to-peer architecture, computers that have traditionally been used solely as clients communicate directly among themselves and can act as both clients and servers. This reduces the load on servers and allows them to perform specialized services more effectively. At the same time, peer-to-peer computing can reduce the need for IT (information technology) organizations to grow parts of its infrastructure in order to support certain services, such as backup storage.

On the Internet, peer-to-peer (referred as P2P) is a type of transient Internet network that allows a group of computer users with the substantially identical networking program to connect with each other and directly access files from one another's storages. Corporations are looking at the advantages of using P2P as a way for employees to share files without the expense involved in maintaining a centralized server and as a way for businesses to exchange information with each other directly.

FIG. 1B illustrates one embodiment of a peer-to-peer network environment (150) that is layered on top of a standard network, such as a Wide-Area Network (WAN) or a Local-Area Network (LAN). Each device node connected to the network 40 may be logically coupled through the network 40 to any of the other nodes on the network 40 to form the peer-to-peer network environment 150. Each node may correspond to one or more physical devices. As illustrated, the peer-to-peer network environment 150 includes device 5, device 10, device 15, device 20, device 25, device 30, and device 35. Each device is at least capable of performing peer-to-peer communications with the other devices functioning as peers in the network environment 150. Peer-to-peer communications includes the sharing of computer resources and services by direct exchange between peer devices (or indirectly though an intermediate peer device). These resources and services may include the exchange of information, processing cycles, cache storage, and disk storage for files among other examples, although all of the resources and services are not required to be present on each peer device. Therefore, each device 5, 10, 15, 20, 25, 30, and 35 in the network 150 may initiate a peer-to-peer communications session in the network environment 150.

Each device also has the capability of identifying devices it would like to communicate or initiate a relationship with, to discover devices entering and leaving the network environment 150 (discovery process), and to determine what communications protocol is being used in the network environment 150. For example, communication between peer devices may be via a wire and/or wireless protocol, such as TCP/IP, Bluetooth, 802.11x protocols commonly referred to as WiFi (Wireless Fidelity), and WAP (Wireless Application Protocol) used to exchange data across mobile telephone networks, among other communication protocols well known in the art.

The devices 5, 10, 15, 20, 25, 30, and 35 may include mobile devices such as a personal digital assistance (PDA), a mobile phone, a portable computer, a pager, a portable music player (e.g., MP3 player), among other devices. Alternatively, the devices 5, 10, 15, 20, 25, 30, and 35 may include typical non-mobile devices, such as a desktop computer, a home entertainment system, a set-top box, a gaming system, among other examples.

It will be appreciated that the peer-to-peer network environment 150 illustrated in FIG. 1B does not limit the configuration of peer-to-peer networks in which the embodiments of the invention may operate. For example, one of skill will readily appreciate that a server may be coupled to the peer-to-peer network to provide centralized services to the peer devices. Furthermore, one of skill in the art will immediately understand that more than one peer-to-peer network environment may be layered on the same underlying network structure and that each peer device may participate in multiple peer-to-peer network environments simultaneously.

Each device 5, 10, 15, 20, 25, 30, and 35 also includes relationship initiation software 50 that facilitates the creation, sharing, modifying, and deletion of persona information, as will be described. Persona information may reflect the personality, behaviors, habits, and personal interests of a user of each device. For example, the persona information for a user of a device may include a set of attributes such as, an artist list, a song list, a favorite song list, a favorite artist list, rating of users, comments on songs, interest list (e.g., vegetarian, chess player, etc), among other attributes that relate to the user. Those of ordinary skill in the art will recognize that numerous attributes may be used and the invention is not limited to only those described herein.

In one embodiment, persona information associated with a user of a device is automatically collected. For example, a list of interests of a user of the device 5 may be automatically generated by recording the web sites the user visits, the music the user listens to, the films the user watches, etc. The persona information may be stored as public and private persona information relating to the user of the device.

The relationship initiation software 50 on each device 5, 10, 15, 20, 25, 30, and 35 also allows the user of each device to initiate a relationship and store persona information from one or more of the other users of the devices on the network. For example, a user may seek to initiate a relationship with another user by initiating a conversation (e.g., querying others for a restaurant recommendation, initiate an instant messaging session, etc.), to share digital content of common interest (e.g., music, poetry, literature, films, pictures, etc), etc. Furthermore, depending on the type of relationship that is generated between the users, a level of trust may be built and visually displayed.

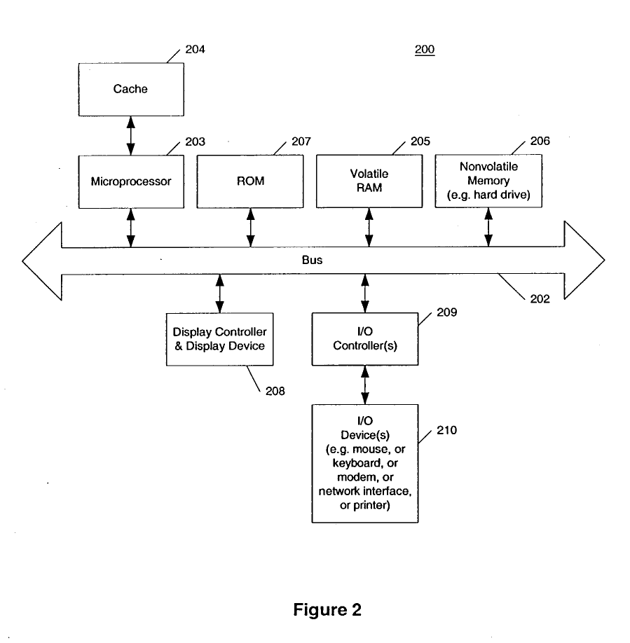

FIG. 2 is a block diagram of a digital processing system which may be used with one embodiment of the invention. For example, the system 200 shown in FIG. 2 may be used as a client computer system (e.g., the client computer systems 102, 104, 118, and/or 120), a Web server system (e.g., the Web server system 128), or a conventional server system, etc. Furthermore, the digital processing system 200 may be used to perform one or more functions of an Internet service provider, such as the ISP 124 and 126.

Note that while FIG. 2 illustrates various components of a computer system, it is not intended to represent any particular architecture or manner of interconnecting the components, as such details are not germane to the present invention. It will also be appreciated that network computers, handheld computers, cell phones, and other data processing systems which have fewer components or perhaps more components may also be used with the present invention. The computer system of FIG. 2 may, for example, be an IBM compatible PC or an Apple Macintosh computer.

As shown in FIG. 2, the computer system 200, which is a form of a data processing system, includes a bus 202 which is coupled to a microprocessor 203 and a ROM 207, a volatile RAM 205, and a non-volatile memory 206. The microprocessor 203, which may be a PowerPC G3 or PowerPC G4 microprocessor from Motorola, Inc. or IBM, is coupled to cache memory 204 as shown in the example of FIG. 2. The bus 202 interconnects these various components together and also interconnects these components 203, 207, 205, and 206 to a display controller and display device 208, as well as to input/output (I/O) devices 210, which may be mice, keyboards, modems, network interfaces, printers, and other devices which are well-known in the art. Typically, the input/output devices 210 are coupled to the system through input/output controllers 209. The volatile RAM 205 is typically implemented as dynamic RAM (DRAM) which requires power continuously in order to refresh or maintain the data in the memory. The non-volatile memory 206 is typically a magnetic hard drive, a magnetic optical drive, an optical drive, or a DVD RAM or other type of memory system which maintains data even after power is removed from the system. Typically the non-volatile memory will also be a random access memory, although this is not required. While FIG. 2 shows that the nonvolatile memory is a local device coupled directly to the rest of the components in the data processing system, it will be appreciated that the present invention may utilize a nonvolatile memory which is remote from the system, such as a network storage device which is coupled to the data processing system through a network interface such as a modem or Ethernet interface. The bus 202 may include one or more buses connected to each other through various bridges, controllers, and/or adapters, as is well-known in the art. In one embodiment, the I/O controller 209 includes a USB (Universal Serial Bus) adapter for controlling USB peripherals. In a peer-to-peer community environment, system 200 may serve as a peer having both client and server capabilities.

According to one embodiment, a list of contents, such as music or movies, may be collected from one or more peers within a community through a multilevel hierarchical searching method based on a user's persona information using a learning mechanism. Persona information of a user may include personal tastes of a particular item or event, such as, for example, genres in music field. Alternatively, persona information may include personal settings of individual environment, such as desktop scheme settings. Other information related to an individual's personal choices may be utilized as persona information. The contents searched and received from the one or more peers may be filtered using multiple levels of details and a learning algorithm, such as a genetic algorithm or a neural network algorithm, based on a user's persona information. For example, in a music space, persona information of a user may include, but not limited to, at least one of the following information:

Genres (e.g., something that a user likes or dislikes)

Interests

Artist lists

Song lists

Favorite songs

Favorite artists

Rating of a user

Comments on the songs

Mood of a song

Beats per minute

Words of the song (e.g., lyrics) The above set of information may be used as parameters, when a user conducts a search, to match people or match a song profile with a person.

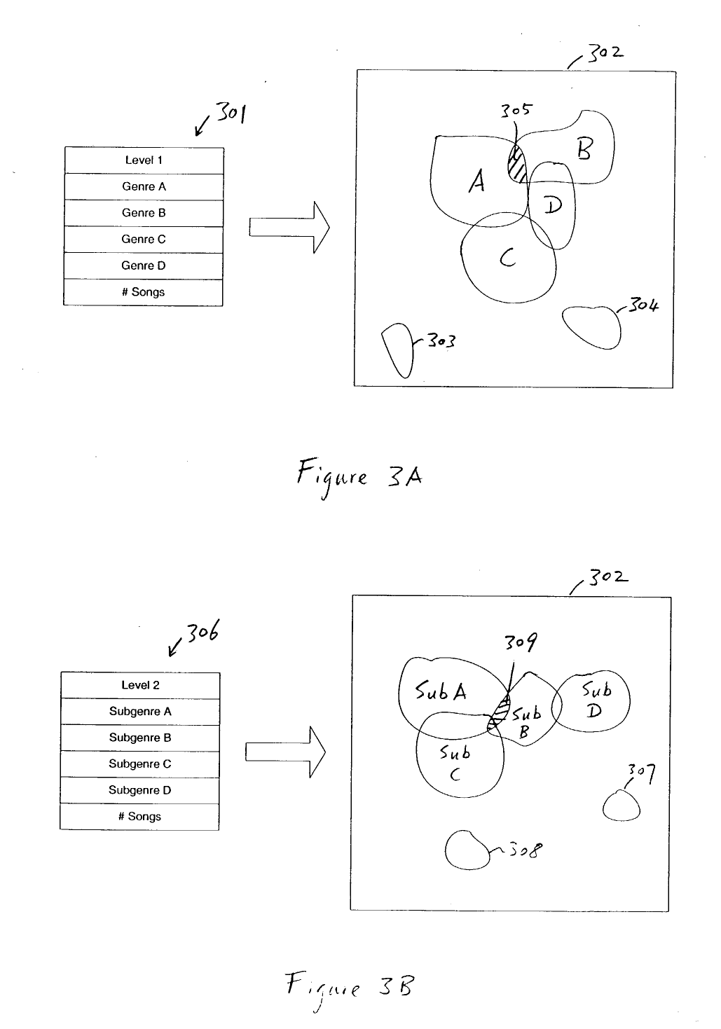

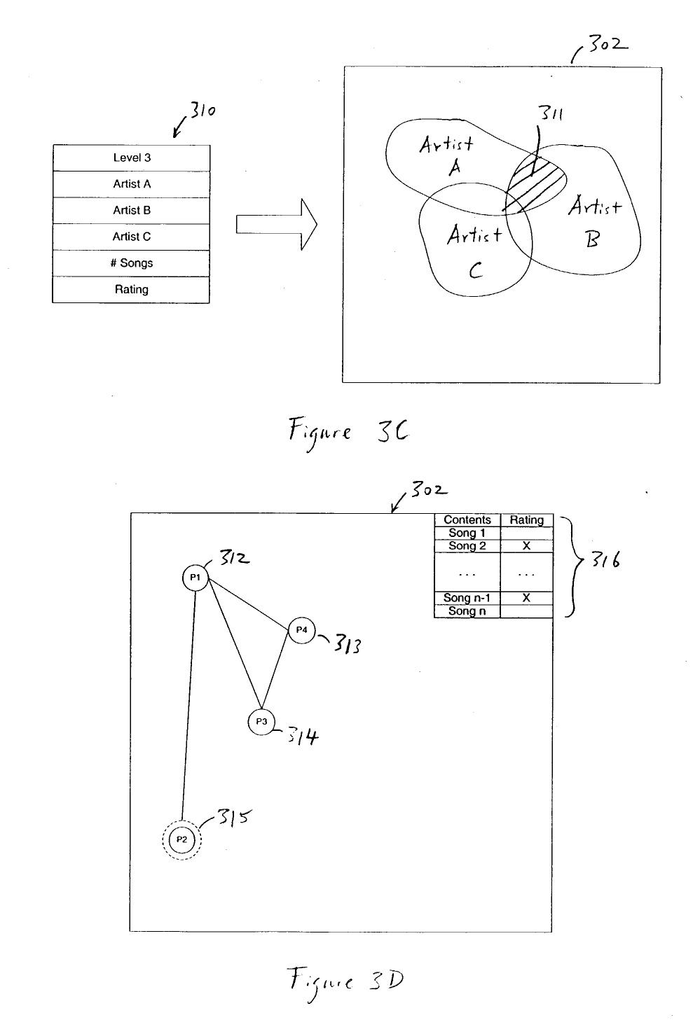

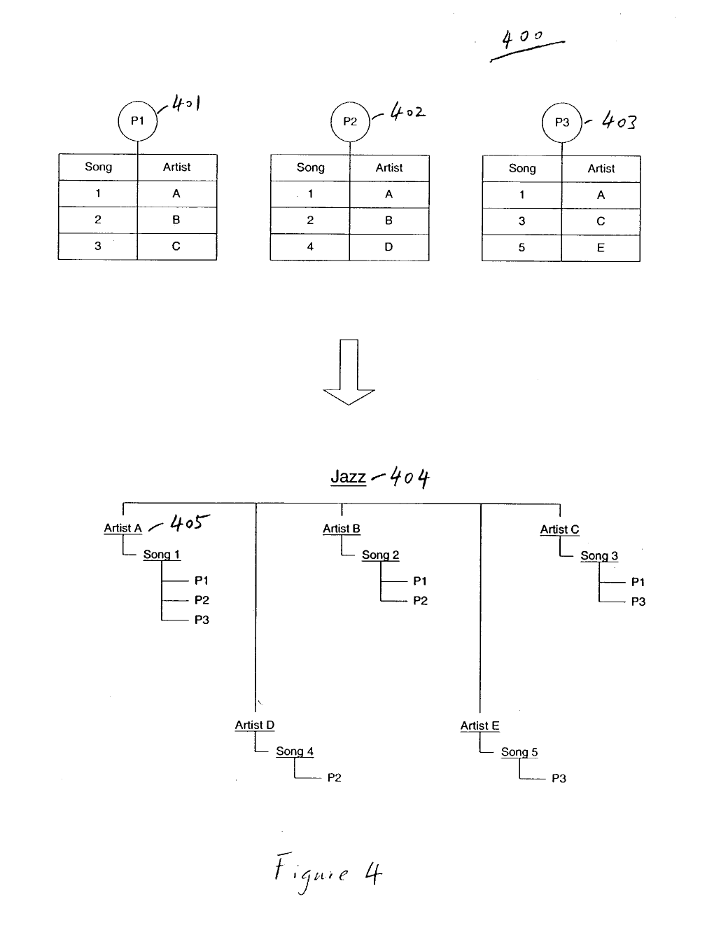

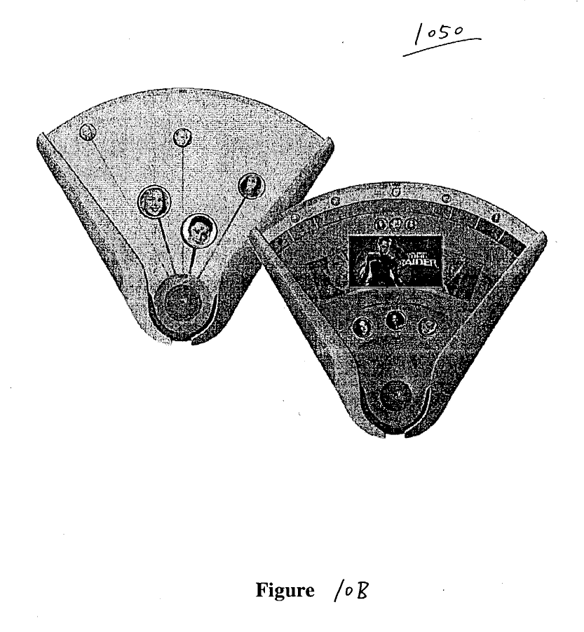

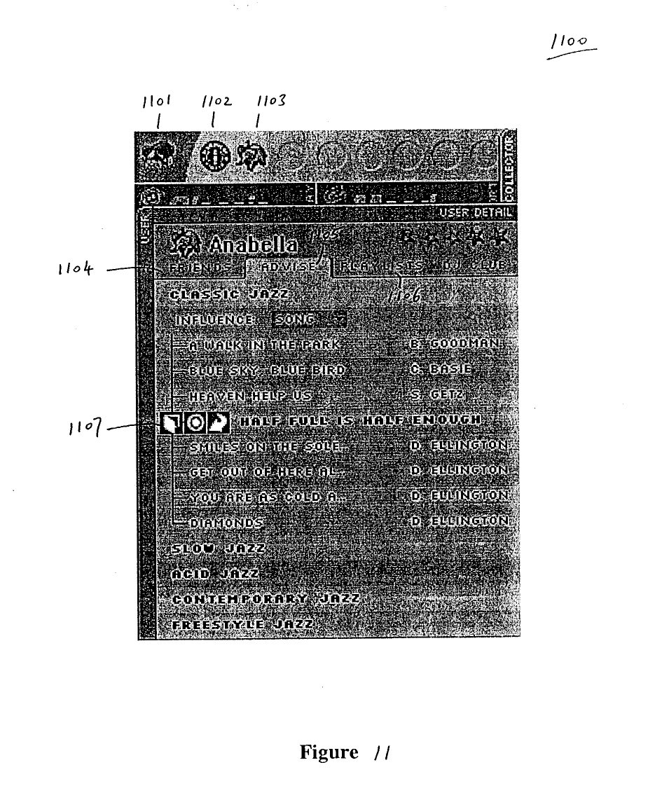

FIGS. 3A to 3D show block diagrams illustrating multilevel hierarchical search and filtering processes based on persona information of a user, according to one embodiment of the invention. Referring to FIG. 3A, when a user initiates a search, a set of parameters 301 may be used to specify how the search is being conducted. In one embodiment, these parameters are set up at run time when the user initiates the search. Alternatively, these parameters may be collected automatically based on user's current or previous behaviors. For example, when a user of a music player (e.g., a MP3 player) starts to play a song, such as a Jazz music, the search instantaneously captures what type of song is being played. In addition, the search may look into what the user did in the past regarding the genres associated with the song, such as Classic Jazz or Acid Jazz, etc. The search then searches among one or more peers within a community and identifies nodes having relevant contents from those peers and displays the nodes associated with the contents in a geographical visualized manner in a display 302. Alternatively, the search may further retrieve (e.g., download) at least portion of the contents from the identified nodes, such as, for example, titles or artists related to the contents. In one embodiment, the display 302 is generated similar to display 1000 or 1050 of FIGS. 10A and 10B. In this embodiment, referring to FIG. 3A, a search result includes clusters of nodes having contents in genres A to D. Clusters of nodes having contents in each cluster are labeled with its associated genres. Other genres such as 303 and 304 may be displayed. However, genres 303 and 304 are not as close as genres A to D to the interests of the user, but somewhat related as determined by the search based on the persona information of the user. The clusters for genres A to D may be overlapped in the display to represent one or more peers in the community that are interested in one or more genres. A user may look into further by specifying an area, such as crossover area 305 which represents those peers who may be interested in both genres A and B.

In one embodiment, the search invokes a learning mechanism or algorithm, such as a genetic algorithm or a neural network algorithm to filter the information collected from the peers. The learning mechanism may store the user selections or preferences regarding the search and filtering for future references. This information may be used by the search during a subsequent search to provide influence on the searches. The learning algorithms involved in the search may alter the search automatically based on the user's past experience or behaviors. Alternatively, the user may specify how much a learning algorithm can alter the search, which will be described in details further below.

In one embodiment, a user specifies how many songs that a peer must have that match the genres A to D, in order to display in the community view. Alternatively, the number of songs used to match a search may be collected automatically by the search based on the user's past preferences and behaviors. It will be appreciated that the embodiment is not limited to the parameters shown in FIGS. 3A to 3D, other parameters, such as those mentioned above may be utilized.

When a user selects an area from a search result displayed, such as area 305, the search will conducts another search and retrieves relevant information from the peers related to the selected area. When a user selects area 305, the search conducts a search and filters the information collected from the peers based on persona information of the user, as well as the user's past preferences or behaviors collected by the learning mechanism, such as genetic algorithm or a neural network algorithm. As a result, as shown in FIG. 3B, the search then searches among one or more peers within a community and identifies nodes having relevant contents, such as sub-genres 306, from those peers and displays the identified nodes in a geographical visualized manner in a display 302. In this embodiment, clusters of nodes having sub-genres A to D are closely positioned in the display, indicating they are similar to one another. Some areas, such as area 309, are overlapped to indicate that more than one peer may be interested in more than one sub-genre. In addition, clusters for other sub-genres, such as sub-genres 307 and 308, may be displayed further away from the clusters for sub-genres A to D, which indicate these clusters of nodes are not as relevant as the clusters for sub-genres A to D, based on in part on the user's persona information.

Similarly, when a user selects an area from the display of the level shown in FIG. 3B, the search may display further detailed information from the search result, such as information 310 regarding to specific artists of the songs derived from those genres or sub-genres, as shown in FIG. 3C. Overlapping area 311 may indicate more than one artist may support similar genres.

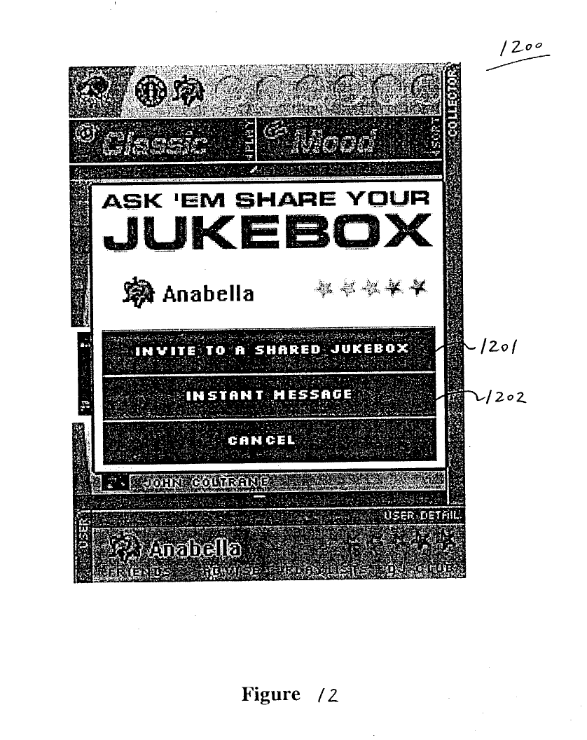

As shown in FIG. 3D, when a user selects an area that indicates which artist or artists the user is interested in, the search displays a result in display 302 showing one or more peers, such as peers 312 to 315, in the community that are interested in the selected artist or artists. Referring to FIG. 3D, lines connecting peers 312, 313, and 314 may indicate that these peers might belong to a sub-community in the community shown in display 302. A user can select any one of the peers in the display 302 to show additional information of the selected peer pertaining to the search. For example, as shown in FIG. 3D, when a user selects peer 315, which is indicated by a dotted circle, a sub-display area 316 may be displayed within the display or view 302 to show what songs this peer is recommending or playing. In one embodiment, the sub-area 316 may be expendable to a full screen display, such as display 1100 of FIG. 11. In addition, the sub-display area 316 may include ratings to one or more songs by the selected peer. The rating information may be displayed based on the user's request, such as those specified by parameters 310 of FIG. 3C. Furthermore, a user may participate in rating of the songs of other peers from, for example, sub-display interface 316. The ratings of the particular songs or contents by the user may be captured by the search which in turn may use that as an influence for the future searches. Other information may be displayed in further details.

It would be appreciated that the multilevel hierarchy shown in FIGS. 3A to 3D are not limited to a specific number of levels. Rather, the processes involved in FIGS. 3A to 3D may be repeated to further obtain finer granularity of the contents search results based on the user's persona information. It is further appreciated that the processes described herein are not limited to a peer-to-peer network community. These processes may be applied to a general network environment, such as a wide area network (WAN) (e.g., the Internet) or a local area network (LAN) (e.g., an Intranet within an organization).

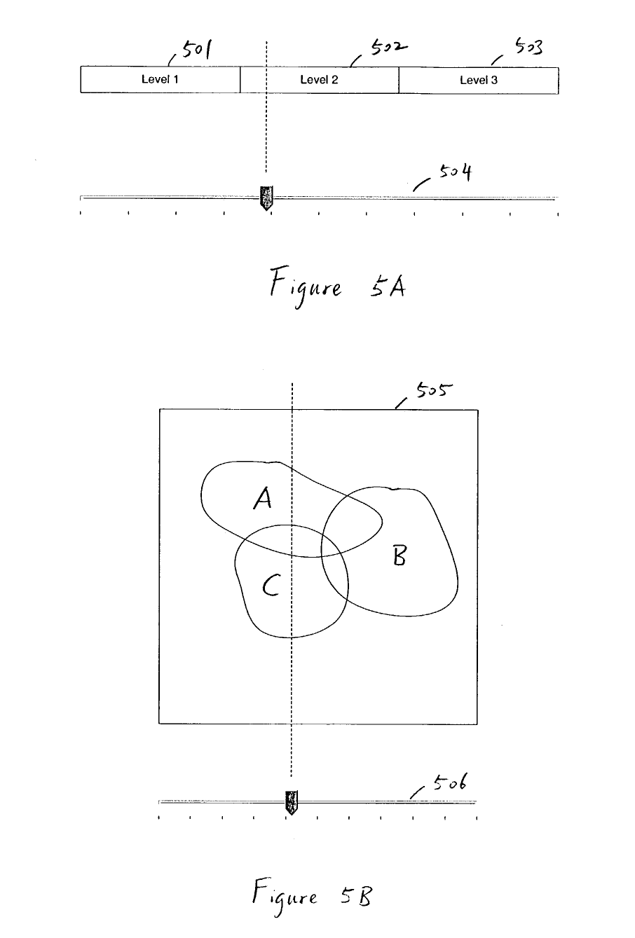

FIG. 4 shows a block diagram illustrating a data presentation format which may be used with one embodiment of the invention. Referring to FIG. 4, the data presentation format 400 may include one or more peers, such as peers 401, 402, and 403. Each of the peers 401 to 403 may include one or more songs authored by one or more artists. When a user conducts a search, the search invokes the user's persona information and a learning mechanism to filter the contents received from the peers. For example, when a user conducts a search for music under general Jazz category. The search issues a search and may generate content information in a format similar to data presentation format 404. Subsequently, when a user selects one of the area from the search result, such as artist 405, the search may retrieve the corresponding information from the branch 405 and display in a display or a community view, such as view 302 shown in FIG. 3D. Other data structures may be utilized.

As mentioned above, according to one embodiment of the invention, the search invokes a learning mechanism, such as a genetic algorithm or a neural network algorithm, to conduct a search based on a user's persona information, current behaviors, or past behaviors. According to one embodiment, the learning mechanism alters a scope or style of the search based on the user's past selections or behaviors. Accordingly, a user interface is provided to allow a user to specify how much (e.g., the user's tolerance) the learning mechanism can alter when a search is conducted.

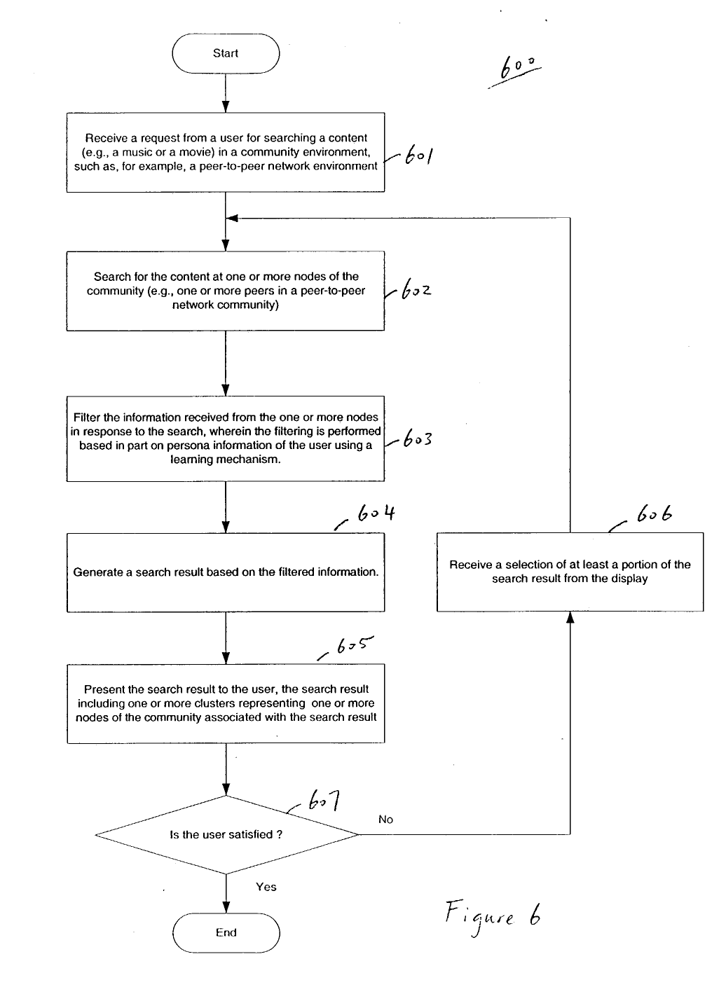

FIGS. 5A and 5B show block diagrams illustrating user interfaces that allow a user to specify how much a learning mechanism can alter the search, according to one embodiment of the invention. In these embodiments, all genomes of the previous levels may give a genome that can be treated by a learning algorithm, such as a genetic process. At some stages the genome may be mutated and crossed over to allow new elements to appear in the rendered views.

Genetic algorithms belong to the class of stochastic search methods and they operate on a population of solutions. To use a genetic algorithm, a user typically encodes solutions to his/her problem in a structure that can be stored in a computer memory. This object is called a genome (or chromosome). The genetic algorithm creates a population of genomes and applies crossover and mutation to the individuals in the population to generate new individuals. It uses various selection criteria so that it picks the best individuals for mating (and subsequent crossover). The objective function determines how “good” each individual is. Further detailed information regarding a genetic algorithm can be found at the following Web site: http://lancet.mit.edu/˜mbwall/presentations/IntroToGAs/P002.html

In one embodiment, a slider, such as sliders 504 and 506, may be used to indicate how much alteration the user wants. Other mechanisms, such as a circle, may be used for the indication purposes. The user interface may be just a bar indicating different levels (e.g., levels 501, 502, 503) of hierarchy that a learning mechanism can alter, as shown in FIG. 5A. Alternatively, a geographic view, such as view 505 may be used, as shown in FIG. 5B. Other configurations may exist.

FIG. 6 is a flow diagram illustrating a process for filtering contents in accordance with one embodiment of the invention. In one embodiment, the process 600 includes receiving a request from a user for searching a content in a community environment, searching for the content at one or more nodes of the community, filtering information received from the one or more nodes in response to the searching, wherein the filtering is performed based on persona information of the user using a first learning mechanism, and generating a first search result based on the filtered information.

Referring to FIG. 6, at block 601, a request to search for a content or contents, such as a music or a movie, in a community environment is received from a user. In one embodiment, the community is a peer-to-peer network community. The community may be a wide area network (WAN), such as the Internet. Alternatively, the community may be a local area network (LAN), such as an Intranet within an organization. At block 602, the process searches for the contents at one or more nodes (e.g., one or more peers within a peer-to-peer community). After receiving information from the one or more nodes of the community in response to the search, at block 603, the process filters the information based on in part on persona information of the user.

In one embodiment, the persona information includes genres, interests, and other personal preferences as mentioned above. In one embodiment, the filtering is performed using a learning mechanism, such as, for example, a genetic algorithm or a neural network algorithm. The learning mechanism may record or store previous preferences or behaviors of the user regarding similar searches or contents being searched. The learning mechanism may automatically alter some searching rules or criteria based on the information learned from the user's past actions or behaviors. Alternatively, the learning mechanism may alter the search based on the tolerance allowed by the respective user. Such tolerance may be set by the user through a user interface, such as user interfaces shown in FIGS. 5A and 5B.

In one embodiment, the filtering operations may be performed by a node of the user who initiates the search. In an alternative embodiment, the filtering operations may be performed by one or more nodes within the community who provide those contents being searched, in a distributed manner. In this embodiment, the user may initiate the search by transmitting part of its persona information or preferences to the respective nodes in the community. The respective nodes may perform such filtering operations using their own processing resources, rather than user's processing resources. As a result, the process of finding content is speed up for the user, since the algorithm helps on exploring a space that is relatively large to search exhaustively. Unlike a conventional approach, such as one used by Google Technology, which puts the best hits up front for the user, the process described herein is tailored to the user's persona. Accordingly, the network traffic is reduced since the operations are performed on a relatively small part of the information. In a further embodiment, some of the contents may be processed by the initiating user's node and the rest of the contents may be processed at the respective nodes, dependent upon the bandwidth of the respective nodes (e.g., network connections between the respective nodes). Furthermore, the filtering operations may be performed at a centralized server, such as, for example, Web server 128 of FIG. 1A. Other configurations may be utilized.

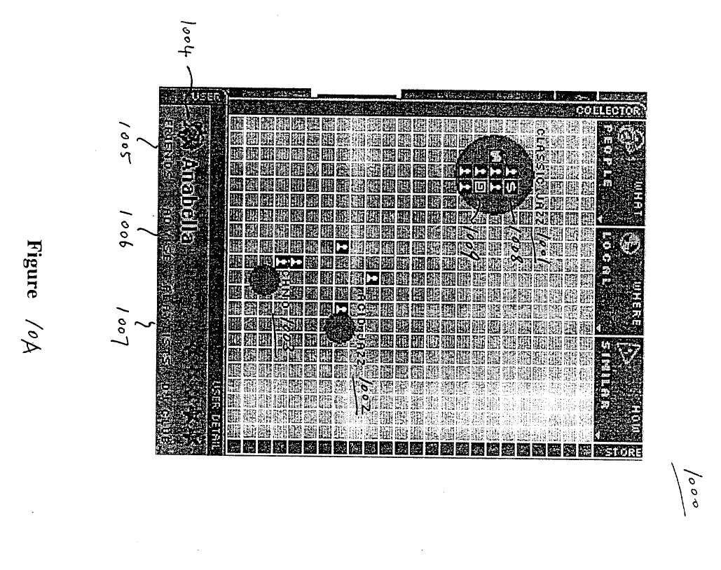

Referring back to FIG. 6, at block 604, a search result (e.g., a hit list) is generated based on the filtered information. The underlined information of the search result may be formatted similar to the data presentation format shown in FIG. 4. At block 605, the search result is presented to the user. In one embodiment, the search result is presented in a geographic visualized manner including one or more clusters representing one or more nodes of the community associated with the search. The search result may be represented in a community view similar to those shown in FIGS. 9 to 12, which will be described in detail further below.

If, at block 607, the user is not satisfied with the result, at block 606, the user may select a portion of the search result from the display or view by, for example, circling an area in which the user may be interested. The above processes may be repeated until the user is satisfied with the results.

According to one embodiment, the search for contents is initiated by a user at a node, as described above. According to another embodiment, the search may be performed automatically based on the user's current or past behaviors. For example, on a portable device, such as a CD player, the search and filtering processes may be performed automatically. The selection of the relevant parameters may be predetermined by the search and gets adapted over time through a learning mechanism, such as a genetic algorithm or a neural network algorithm. During a search, the search may alter the search parameters. For example, when a user selects certain genres, artists, and songs, new elements may be provided by the learning processes. Alternatively, the user's listening patterns may be used to match his current behaviors.

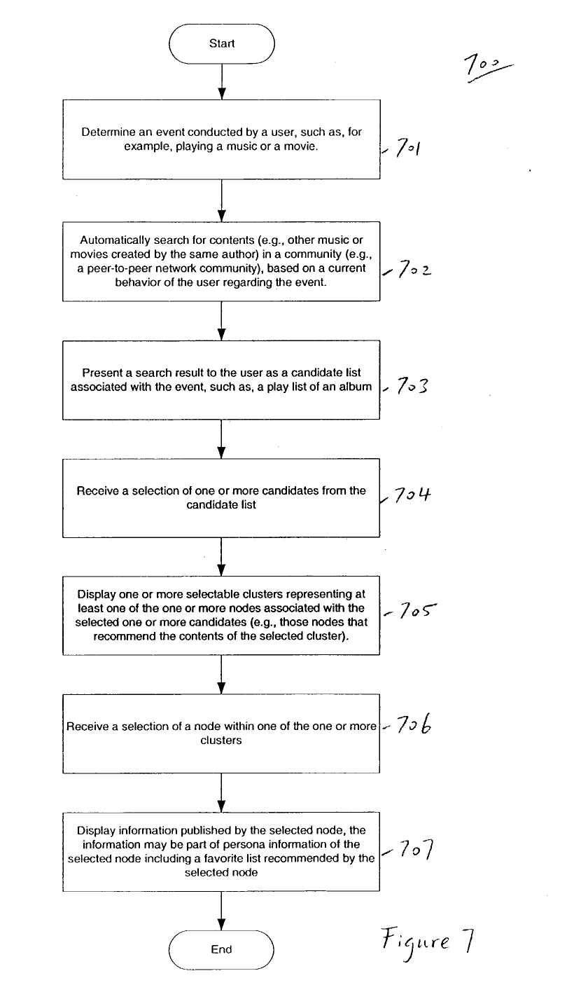

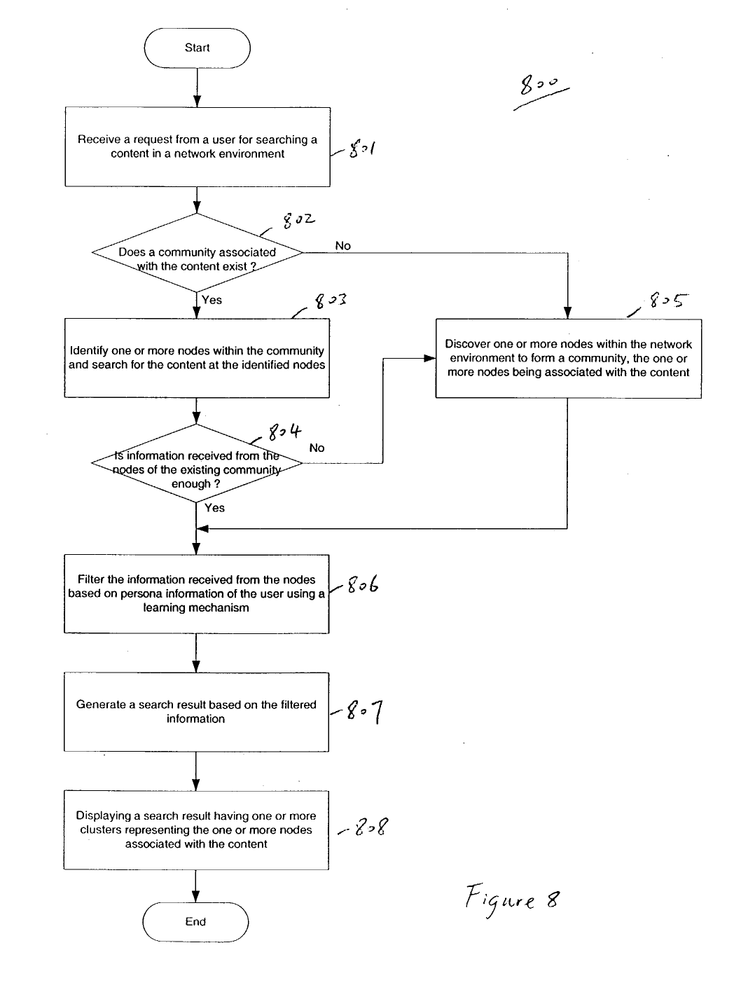

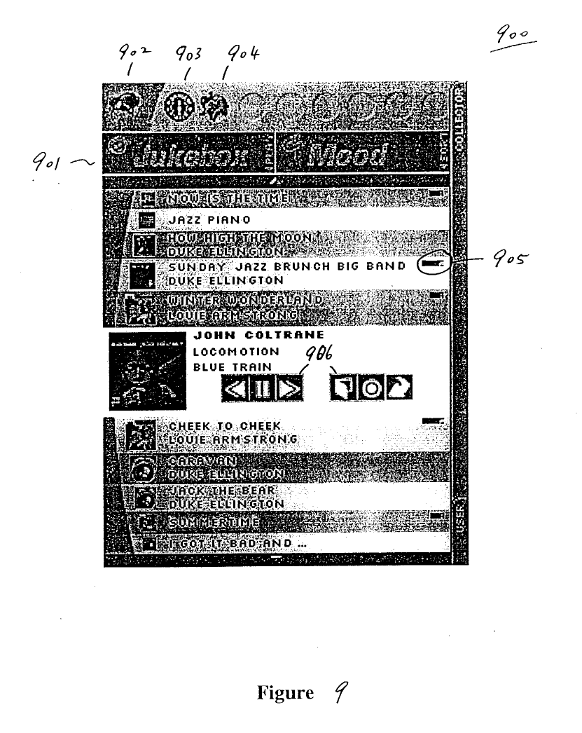

FIG. 7 is a flow diagram illustrating a process for filtering contents, in accordance with one embodiment of the invention. In one embodiment, the process 700 includes determining an event conducted by a user, automatically searching for contents in a community environment based on a current behavior of the user regarding the event, and presenting a search result to the user as a candidate list associated with the event.

Referring to FIG. 7, at block 701, the process determines an event currently associated with a user, such as, for example, playing a song or a movie. At block 702, the process automatically searches for contents (e.g., other music or movies created by the similar authors) in a community, such as a peer-to-peer network community, based on current behaviors of the user regarding the event. At block 703, a search result is presented to the user as a candidate list associated with the event, such as, for example, a play list of an album. The search result may be filtered based on persona information of the user via a learning mechanism, using one of the mechanisms described above.

At block 704, a selection of one or more candidates from the list is received and at block 705, in response to the selection, the process displays one or more selectable clusters representing at least one of the one or more nodes associated with the selected one or more candidates (e.g., those nodes that are currently recommending the contents of the selected clusters). At block 706, a selection of one of the one or more clusters is received and at block 707, the process displays information published by the selected nodes. The information displayed may be part of the persona information of the selected node including, for example, a favorite list recommended by the respective node. The information displayed may be presented in a manner similar to one shown in FIG. 9.

It will be appreciated that the search is not limited to contents on those nodes within an existing community. Contents beyond the existing community could be searched, according to one embodiment. For example, when a user initiates a search for a particular content, such as Jazz music which may be popular in New Orleans but not heard of in San Francisco. As a result, when a user of a community in San Francisco initiates a search for Jazz music in San Francisco, the existing community around San Francisco may not have enough information available for the search. According to one embodiment of the invention, the search may go beyond the existing community and discover new nodes around New Orleans, and form a new community with those newly discovered nodes or peers. Thereafter, the contents of those nodes may be shared by the newly created community.

FIG. 8 is a flow diagram illustrating a process for searching and filtering contents in accordance with one embodiment of the invention. In one embodiment, the process 800 includes receiving a request from a user for searching a content in a network environment, discovering one or more nodes within the network environment to form a community, the one or more nodes being associated with the content, and displaying a search result having one or more clusters representing the one or more nodes associated with the content.

Referring to FIG. 8, at block 801, a request for searching a content or contents in a community is received. At block 802, the process determines whether there is an existing community pertaining to the contents being searched. If there is an existing community, at block 803, the process identifies one or more nodes within the existing community and searches for the contents at the identified nodes. At block 804, if the information received from the identified nodes of the existing community is not enough, or alternatively, if there is no existing community pertaining to the contents being searched, at block 805, the process discovers one or more nodes to form a new community pertaining to the contents being searched.

In one embodiment, the process invokes a genetic algorithm which is based on genome and a LOD (level of details) approach. The genome and LOD define what will get displayed. The nodes may be picked based on the current learning states and LOD being used. According to one embodiment, certain thresholds may be designed for each level which determine how much data will be displayed. This is similar to those defining how many hits a user like to see in a search. For example, for a top level, it might be 100 nodes and for a second level (e.g., the artist level), it might be 1000 songs, etc. The respective user might want to stipulate how dense the visualization of the search results is. In addition, the user might want to stipulate how much side information (e.g., related but somewhat off) hits are shown. In one embodiment, a user may enter this information through a graphical user interface (GUI). Alternatively, the threshold information may be collected automatically based on the user's past experience.

Referring back to FIG. 8, at block 806, the process filters the information received from the nodes based on the persona information of the user using a learning mechanism, such as a genetic algorithm or a neural network algorithm. At block 807, a search result is generated based on the filtered information and at block 808, the search result is displayed in a geographic visualized manner similar to those shown in FIGS. 9-11 and 3A-3D, as discussed above. The search result displayed may include one or more clusters representing one or more genres or nodes associated with the contents.

FIG. 9 shows a user interface which may be used with an embodiment of the invention. For example, the interface 300 may be a graphical user interface (GUI) of a multimedia player, such as a music player, executed at a peer of a P2P community, such as peers 102, 104, 118, or 120 of FIG. 1A. A program having user interface 900 may be stored at a memory of a peer, such as nonvolatile memory 206 of peer 200 shown in FIG. 2. When the program is launched by a processor (e.g., processor 203), user interface 900 may be displayed in a display device (e.g., display device 208).

Referring to FIG. 9, in one embodiment, interface 900 includes, among others, a play list 901 called Jukebox. Within a display window of interface 900, a list of songs is displayed. All titles that are not on the home peer system indicate their origin on the right side of interface 900, such as indication 905. These songs may be shared or downloaded from other peers via a network interface, such as IO interface 210 of system 200, over a network. The songs not on the home system may be stored at a respective peer's storage. Alternatively, they may be stored at a centralized server hosting the community, such as, for example, Web server 128. As a result, the device having interface 900 may be used as a traditional stand-alone player, a community listening environment, or a mini-broadcast station.

In addition, according to one embodiment of the invention, interface 900 includes one or more play controls 906 to directly control one or more songs being played. Furthermore, according to an alternative embodiment, interface 300 includes one or more friends (e.g., buddies), such as buddies 902-904, who may be associated with or be interested in one or more songs in the list. According to one embodiment, a selection of one of the buddies may display information regarding the selected buddy, which will be described in details further below. Other information apparent to those with ordinary skills in the art may be included. According to one embodiment, the list of songs listed may be collected and filtered through a multilevel hierarchical searching method based on a user's persona information using a learning mechanism over the community, which will be described in details further below.

Finding new items often is a task that is performed on a home PC. It is desirable to allow a user to explore a community while being mobile and socially active. According to one embodiment, while listening to a music, a user is able to visualize its surroundings and examine the quality of peers they can participate with.

FIG. 10A shows a user interface which may be used to display one or more peers in a community in a geographical visualized manner, according to an embodiment of the invention. For example, while a user of a peer is listening to one of the songs in his/her play list, such as one shown in FIG. 9, the user may want to display where those songs, which are not residing at user's home system, come from. The user may invoke user interface 1000 to display those peers in a community. According to one embodiment, this view can be used, for example, to find other people with similar interests or even an expert in order to get some recommendation of a content, such as a music.

The community view 1000 shows three groups a user has interests in, such as Classic Jazz, Acid Jazz, and Techno. The surrounding users are automatically visualized neared to the groups that best describe their own interests. This type of view is also referred to as Affinity Visualization. In this way, a user can observe the surrounding user makeup, request information on each of the individuals, identify a group they are interested in, and automatically build a play list from the content available in the observed community. According to one embodiment, the play list automatically built up includes a set of contents collected through a multilevel hierarchical searching method based on a user's persona information using a learning mechanism over the community, which will be described in details further below.

For the definition of the above used term “surrounding”, a certain physical proximity can serve as a natural boundary and offers possibilities for “hot-spot” like services on a limited domain, such as a university campus or a cafe. However, the technology described here is not limited to limited domains. They can be applied to a larger domain and can be extended to virtual communities on the Internet. According to one embodiment, the groups shown in interface 1000 can be freely arranged on the display by a user through, for example, drag and drop operations.

Referring to FIG. 10A, user interface 1000 may include one or more groups of peers, such as groups 1001, 1002, and 1003 with similar interests or genres. For example, group 1001 is formed by those peers, such as peers 1008 and 1009, who are interested in Classic Jazz, while groups 1002 and 1003 are formed by those peers who are interested in Acid Jazz and Techno respectively. A peer may be interested on more than one group. It would be appreciated that groups 1001 to 1003 may be formed based on other information, such as, for example, artists of the songs, etc.

In addition, user interface 1000 may display a name 1004 of current peer hosting the interface 1000 when a corresponding peer, such as peer 1009, is selected. Name 1004 may be a real name of a user. Alternatively, name 404 may be an alias name dedicated to a user. A user or a peer may have more than one alias name corresponding to a real name. These alias names may be used to communicate with other peers without revealing the peer's true identity. A peer may use one alias name in one community while using another alias name in another community.

Furthermore, according to one embodiment, interface 1000 includes a buddy tab 405 which when selected, a list of buddies would be displayed. Interface 1000 may include an advise tab 1006 which when selected, a list of contents (e.g., a list of songs) recommended by the current peer may be displayed. Interface 1000 may further include a play list tab 1007, which when selected, a current play list of multimedia contents may be displayed. Other elements apparent to those with ordinary skills in the art may be included.

It would be appreciated that user interface 1000 is not limited to a configuration shown in FIG. 10A, other types of user interface, such as user interface 1050 shown in FIG. 10B may be utilized. In this embodiment, a picture of the corresponding peer may be used to indicate the peer. It would be appreciated that other symbolic items, such as an icon or a bitmap, may be utilized to display as a peer.

FIG. 11 shows a user interface which may be used with one embodiment of the invention. For example, when a user of current peer selects advise tab 1006 from interface 1000 of FIG. 10A, user interface 1100 may be used to show a list of songs the current peer is currently recommending. The list of songs recommended may be collected and filtered through a multilevel hierarchical searching method based on a user's persona information using a learning mechanism over the community, which will be described in details further below.

A traditional way of gaining recommendations is through friends and trusted people. A successful service needs to take advantage of the dynamic Web of communities to be able to increase the usefulness of distribution. Some of the individuals found in a community view might recommend new tracks to an interested user, which in turn might create a new play list out of the newly acquired tracks.

Referring to FIG. 11, similar to user interface 900 of FIG. 9, user interface 1100 also includes buddies 1101 to 1103 displayed within the interface, as well as buddy list tab 1104, advise tab 1105, and play list tab 1106, etc., such that a user may be able to switch back and forth between different screens or interfaces. In addition, user interface 1100 may include a play control 1107 to control any one of the songs listed. Other elements may be included.

In addition to query from the rest of peers in the community, a user of a peer may actively go out and invite other peers to join with the user to share its contents. FIG. 12 shows a user interface 1200, according to one embodiment, which can be used by a user to invite other peers, via control 1201, to participate in a particular session. In addition, the user may send a recommendation to a friend or talk to a friend through instant messaging 1202. Other communication mechanisms may be utilized.

Thus, techniques for search and filtering information in a community have been described. In the foregoing specification, the invention has been described with reference to specific embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computerized method comprising:
receiving a request from a user to search for a content in a community environment;
searching for the content at one or more nodes of the community environment;
filtering information received from the one or more nodes in response to the searching, wherein the filtering is performed based on persona information of the user using a first learning mechanism; and
generating a first search result based on the filtered information.

2. The computerized method of claim 1, wherein the community environment is a peer-to-peer community environment.

3. The computerized method of claim 1, wherein the first learning mechanism is one of a genetic algorithm and a neural network algorithm.

4. The computerized method of claim 1, wherein the first learning mechanism records user's behavior on the searching to provide further influence on subsequent searches.

5. The computerized method of claim 1, wherein the request is sent automatically when the user performs certain events associated with the user's persona information.

6. The computerized method of claim 1, wherein the persona information includes information selected from the group consisting of:
genres of the user;
interests of the user;
an author of the content;
user's favorites in genres of the content;
comments regarding the content;
a rating on the content;
a mood of the content; and
words within the content.

7. The computerized method of claim 1, further comprising presenting the first search result to the user in an interactive visualized manner.

8. The computerized method of claim 7, wherein the selectable visualized manner includes one or more selectable clusters representing at least one of the one or more nodes associated with the content.

9. The computerized method of claim 7, further comprising:
receiving a selected portion of the first search result;
searching for further contents associated with the selected portion of the first search result; and
generating a second search result based on the persona information of the user using a second learning mechanism.

10. The computerized method of claim 9, further comprising presenting the second search result to the user, the second search result including one or more clusters representing one or more nodes of the community associated with the second search result.

11. A computerized method, comprising:
determining an event associated with a user;
automatically searching for contents in a community environment based on a current behavior of the user pertaining to the event; and
presenting a search result to the user as a candidate list associated with the event.

12. The computerized method of claim 11, wherein the community environment is a peer-to-peer network environment.

13. The computerized method of claim 11, wherein the search result is generated based on persona information of the user using a learning mechanism.

14. The computerized method of claim 13, wherein the persona information includes information selected from the group consisting of:
genres of the user;
interests of the user;
an author of the content;
user's favorites in genres of the content;
comments regarding the content;
a rating on the content;
a mood of the content; and
words within the content.

15. The computerized method of claim 11, wherein the search result is generated based in part on previous behaviors of the user pertaining to the event.

16. The computerized method of claim 11, wherein the event is a multimedia event is one of a music and a movie.

17. The computerized method of claim 11, further comprising:
receiving a selection of one or more candidates from the candidate list; and
displaying one or more selectable clusters representing at least one of the one or more nodes associated with the selected one or more candidates.

18. The computerized method of claim 17, further comprising:
receiving a selection of a node within one of the one or more clusters; and
displaying information associated with the selected node.

19. The computerized method of claim 18, wherein the information published by the selected node includes a current behavior of a user associated with the node.

20. A computerized method, comprising:
receiving a request from a user to search for a content in a network environment;
discovering one or more nodes within the network environment to form a community, the one or more nodes being associated with the content; and
displaying a search result having one or more clusters representing the one or more nodes associated with the content.

21. The computerized method of claim 20, further comprising:
determining an event associated with the user; and
automatically generating the request based on a current behavior of the user pertaining to the event.

22. The computerized method of claim 21, wherein the request is generated based further in part on previous behaviors of the user regarding the event.

23. The computerized method of claim 20, further comprising:
filtering information received from the one or more discovered nodes based on persona information of the user using a learning mechanism; and
generating the search result based on the filtered information.

24. The computerized method of claim 23, wherein the learning mechanism is one of a genetic algorithm and a neural network algorithm.

25. The computerized method of claim 23, wherein the persona information includes information selected from the group consisting of:
genres of the user;
interests of the user;
an author of the content;
user's favorites in space of the content;
comments regarding the content;
a rating on the content;
a mood of the content; and
words within the content.

26. A machine-readable medium having executable instructions to a cause a device to perform a method comprising:
receiving a request from a user to search for a content in a community environment;
searching for the content at one or more nodes of the community environment;
filtering information received from the one or more nodes in response to the searching, wherein the filtering is performed based on persona information of the user using a first learning mechanism; and
generating a first search result based on the filtered information.

27. The machine-readable medium of claim 26, wherein the community environment is a peer-to-peer community environment.

28. The machine-readable medium of claim 26, wherein the first learning mechanism is one of a genetic algorithm and a neural network algorithm.

29. The machine-readable medium of claim 26, wherein the first learning mechanism records user's behavior on the searching to provide further influence on subsequent searches.

30. The machine-readable medium of claim 26, wherein the request is sent automatically when the user performs certain events associated with the user's persona information.

31. The machine-readable medium of claim 26, wherein the persona information includes information selected from the group consisting of:
genres of the user;
interests of the user;
an author of the content;
user's favorites in genres of the content;
comments regarding the content;
a rating on the content;
a mood of the content; and
words within the content.

32. The machine-readable medium of claim 26, wherein the method further comprises presenting the first search result to the user in an interactive visualized manner.

33. The machine-readable medium of claim 32, wherein the selectable visualized manner includes one or more selectable clusters representing at least one of the one or more nodes associated with the content.

34. The machine-readable medium of claim 32, wherein the method further comprises:
receiving a selected portion of the first search result;
searching for further contents associated with the selected portion of the first search result; and
generating a second search result based on the persona information of the user using a second learning mechanism.

35. The machine-readable medium of claim 34, wherein the method further comprises presenting the second search result to the user, the second search result including one or more clusters representing one or more nodes of the community associated with the second search result.

36. A node comprising:
a processor coupled to a memory through a bus; and
a process executed by the processor from the memory to cause the processor to:
receive a request from a user to search for a content in a community environment;
search for the content at one or more nodes of the community environment;
filter information received from the one or more nodes in response to the searching, wherein the filtering is performed based on persona information of the user using a first learning mechanism; and
generate a first search result based on the filtered information.

37. An apparatus, comprising:
means for receiving a request from a user to search for a content in a community environment;
means for searching for the content at one or more nodes of the community environment;
means for filtering information received from the one or more nodes in response to the searching, wherein the filtering is performed based on persona information of the user using a first learning mechanism; and
means for generating a first search result based on the filtered information.

38. A machine-readable medium having executable instructions to a cause a device to perform a method comprising:
determining an event associated with a user;
automatically searching for contents in a community environment based on a current behavior of the user pertaining to the event; and
presenting a search result to the user as a candidate list associated with the event.

39. The machine-readable medium of claim 38, wherein the community environment is a peer-to-peer network environment.

40. The machine-readable medium of claim 38, wherein the search result is generated based on persona information of the user using a learning mechanism.

41. The machine-readable medium of claim 40, wherein the persona information includes information selected from the group consisting of:
genres of the user;
interests of the user;
an author of the content;
user's favorites in genres of the content;
comments regarding the content;
a rating on the content;
a mood of the content; and
words within the content.

42. The machine-readable medium of claim 38, wherein the search result is generated based in part on previous behaviors of the user pertaining to the event.

43. The machine-readable medium of claim 38, wherein the event is a multimedia event is one of a music and a movie.

44. The machine-readable medium of claim 38, wherein the method further comprises:
receiving a selection of one or more candidates from the candidate list; and
displaying one or more selectable clusters representing at least one of the one or more nodes associated with the selected one or more candidates.

45. The machine-readable medium of claim 44, wherein the method further comprises:
receiving a selection of a node within one of the one or more clusters; and
displaying information associated with the selected node.

46. The machine-readable medium of claim 45, wherein the information published by the selected node includes a current behavior of a user associated with the node.

47. A node comprising:
a processor coupled to a memory through a bus; and
a process executed by the processor from the memory to cause the processor to:
determining an event associated with a user;
automatically search for contents in a community environment based on a current behavior of the user pertaining to the event; and
present a search result to the user as a candidate list associated with the event.

48. An apparatus, comprising:
means for determining an event associated with a user;
means for automatically searching for contents in a community environment based on a current behavior of the user pertaining to the event; and
means for presenting a search result to the user as a candidate list associated with the event.

49. A machine-readable medium having executable instructions to a cause a device to perform a method comprising:
receiving a request from a user to search for a content in a network environment;
discovering one or more nodes within the network environment to form a community, the one or more nodes being associated with the content; and
displaying a search result having one or more clusters representing the one or more nodes associated with the content.

50. The machine-readable medium of claim 49, wherein the method further comprises:
determining an event associated with the user; and
automatically generating the request based on a current behavior of the user pertaining to the event.

51. The machine-readable medium of claim 50, wherein the request is generated based further in part on previous behaviors of the user regarding the event.

52. The machine-readable medium of claim 49, wherein the method further comprises:
filtering information received from the one or more discovered nodes based on persona information of the user using a learning mechanism; and
generating the search result based on the filtered information.

53. The machine-readable medium of claim 52, wherein the learning mechanism is one of a genetic algorithm and a neural network algorithm.

54. The machine-readable medium of claim 52, wherein the persona information includes information selected from the group consisting of:
genres of the user;
interests of the user;
an author of the content;
user's favorites in space of the content;
comments regarding the content;
a rating on the content;
a mood of the content; and
words within the content.

55. A node comprising:
a processor coupled to a memory through a bus; and
a process executed by the processor from the memory to cause the processor to:
receive a request from a user to search for a content in a network environment;
discover one or more nodes within the network environment to form a community, the one or more nodes being associated with the content; and
display a search result having one or more clusters representing the one or more nodes associated with the content.

56. An apparatus, comprising:
means for receiving a request from a user to search for a content in a network environment;
means for discovering one or more nodes within the network environment to form a community, the one or more nodes being associated with the content; and
means for displaying a search result having one or more clusters representing the one or more nodes associated with the content.
